(19) United States
(12) Patent Application Publication
(10) Pub. No.: US 2024/0253981 A1
(43) Pub. Date: Aug. 1, 2024

(54) METHODS AND SYSTEMS FOR PROVIDING INTELLIGENT AUTONOMOUS HYDROGEN PRODUCTION MANAGEMENT

(71) Applicant: HONEYWELL INTERNATIONAL INC., Charlotte, NC (US)

(72) Inventors: Viraj Srivastava, Bengaluru (IN); Praveen Sam, Cypress, TX (US); Niranjan Amrutur Subba Rao, Bangalore (IN)

(21) Appl. No.: 18/420,781

(22) Filed: Jan. 24, 2024

(30) Foreign Application Priority Data
Jan. 27, 2023 (IN) 202311005476

(51) Int. Cl. C01B 3/02; G06N 20/20; G06Q 50/04

(52) U.S. Cl. CPC C01B 3/02; G06Q 50/04; C01B 2203/16; G06N 20/20

(57) ABSTRACT

Example methods, apparatuses, systems, and computer program products are provided. For example, an example computer-implemented method includes receiving a plurality of runtime hydrogen production variable indicators from a hydrogen production control system associated with a hydrogen production facility, generating at least one predicted hydrogen production operation indicator. Further, in response to determining that the at least one predicted hydrogen production operation indicator does not satisfy the at least one corresponding hydrogen production operation threshold indicator, generating an adjusted hydrogen production variable indicator corresponding to a runtime hydrogen production variable indicator, and transmitting the adjusted hydrogen production variable indicator to the hydrogen production control system.

### CROSS-REFERENCE TO RELATED APPLICATIONS

This application claims the benefit of priority of IN Patent Application No. 202311005476, titled “INTELLIGENT AUTONOMOUS PRODUCTION MANAGEMENT FOR HYDROGEN”, filed on Jan. 27, 2023, which is herein incorporated by reference in its entirety.

### FIELD OF THE INVENTION

Example embodiments of the present disclosure relate generally to autonomous systems. For example, example embodiments of the present disclosure may be implemented in hydrogen production management.

### BACKGROUND

Applicant has identified many technical challenges and difficulties associated with manufacturing devices, systems, and methods, including, but not limited to, manufacturing devices, systems, and methods related to hydrogen.

### BRIEF SUMMARY

Various embodiments described herein relate to methods, apparatuses, and systems for hydrogen production management are provided.

In accordance with various embodiments of the present disclosure, an apparatus is provided. In some embodiments, the apparatus comprises at least one processor and at least one non-transitory memory comprising a computer program code. In some embodiments, the at least one non-transitory memory and the computer program code are configured to, with the at least one processor, cause the apparatus to receive a plurality of runtime hydrogen production variable indicators from a hydrogen production control system associated with a hydrogen production facility, generate at least one predicted hydrogen production operation indicator based at least in part on inputting the plurality of runtime hydrogen production variable indicators to one or more hydrogen production machine learning models, determine whether the at least one predicted hydrogen production operation indicator satisfies at least one corresponding hydrogen production operation threshold indicator associated with the hydrogen production facility. Further, in response to determining that the at least one predicted hydrogen production operation indicator does not satisfy the at least one corresponding hydrogen production operation threshold indicator, generate an adjusted hydrogen production variable indicator corresponding to a runtime hydrogen production variable indicator of the plurality of runtime hydrogen production variable indicators, and transmit the adjusted hydrogen production variable indicator to the hydrogen production control system.

In some embodiments, the plurality of runtime hydrogen production variable indicators comprises a production power source variable indicator, a hydrogen production quantity variable indicator, a hydrogen storage location variable indicator, and a hydrogen transport plan variable indicator.

In some embodiments, the at least one predicted hydrogen production operation indicator comprises a predicted hydrogen production safety indicator. In some embodiments, the one or more hydrogen production machine learning models comprise a hydrogen production safety prediction machine learning model.

In some embodiments, the at least one non-transitory memory and the computer program code are configured to, with the at least one processor, cause the apparatus to: receive a plurality of historical hydrogen production variable indicators associated with the hydrogen production facility, receive a plurality of historical hydrogen production safety indicators associated with the hydrogen production facility, and train the hydrogen production safety prediction machine learning model based at least in part on the plurality of historical hydrogen production variable indicators and the plurality of historical hydrogen production safety indicators.

In some embodiments, the one or more hydrogen production machine learning models comprise a hydrogen production cost prediction machine learning model.

In some embodiments, the at least one non-transitory memory and the computer program code are configured to, with the at least one processor, cause the apparatus to: receive a plurality of historical hydrogen production variable indicators associated with the hydrogen production facility, receive a plurality of historical hydrogen production cost indicators associated with the hydrogen production facility, and train the hydrogen production cost prediction machine learning model based at least in part on the plurality of historical hydrogen production variable indicators and the plurality of historical hydrogen production cost indicators.

In some embodiments, the plurality of runtime hydrogen production variable indicators comprises the runtime hydrogen production variable indicator and one or more additional runtime hydrogen production variable indicators.

In some embodiments, prior to transmitting the adjusted hydrogen production variable indicator, the at least one non-transitory memory and the computer program code are configured to, with the at least one processor, cause the apparatus to: generate a predicted hydrogen production operation indicator based at least in part on inputting the adjusted hydrogen production variable indicator and the one or more additional runtime hydrogen production variable indicators to the one or more hydrogen production machine learning models, determine whether the predicted hydrogen production operation indicator satisfies the at least one corresponding hydrogen production operation threshold indicator. Further, in response to determining that the predicted hydrogen production operation indicator satisfies the at least one corresponding hydrogen production operation threshold indicator, transmit the adjusted hydrogen production variable indicator to the hydrogen production control system.

In accordance with various embodiments of the present disclosure, a computer-implemented method is provided. In some embodiments, the computer-implemented method comprises receiving a plurality of runtime hydrogen production variable indicators from a hydrogen production control system associated with a hydrogen production facility, generating at least one predicted hydrogen production operation indicator based at least in part on inputting the plurality of runtime hydrogen production variable indicators to one or more hydrogen production machine learning models, determining whether the at least one predicted hydrogen production operation indicator satisfies at least one corresponding hydrogen production operation threshold indicator associated with the hydrogen production facility. Further, in response to determining that the at least one predicted hydrogen production operation indicator does not satisfy the at least one corresponding hydrogen production operation threshold indicator, generating an adjusted hydrogen production variable indicator corresponding to a runtime hydrogen production variable indicator of the plurality of runtime hydrogen production variable indicators, and transmitting the adjusted hydrogen production variable indicator to the hydrogen production control system.

In accordance with various embodiments of the present disclosure, a computer program product is provided. In some embodiments, the computer program product comprises at least one non-transitory computer-readable storage medium having computer-readable program code portions stored therein. In some embodiments, the computer-readable program code portions comprise an executable portion configured to: receive a plurality of runtime hydrogen production variable indicators from a hydrogen production control system associated with a hydrogen production facility; generate at least one predicted hydrogen production operation indicator based at least in part on inputting the plurality of runtime hydrogen production variable indicators to one or more hydrogen production machine learning models, determine whether the at least one predicted hydrogen production operation indicator satisfies at least one corresponding hydrogen production operation threshold indicator associated with the hydrogen production facility. Further, in response to determining that the at least one predicted hydrogen production operation indicator does not satisfy the at least one corresponding hydrogen production operation threshold indicator, generate an adjusted hydrogen production variable indicator corresponding to a runtime hydrogen production variable indicator of the plurality of runtime hydrogen production variable indicators, and transmit the adjusted hydrogen production variable indicator to the hydrogen production control system.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 is an example system architecture diagram illustrating an example intelligent autonomous hydrogen production management system in accordance with some embodiments of the present disclosure;

FIG. 2 illustrates an example hydrogen production control system in accordance with some embodiments of the present disclosure;

FIG. 3 illustrates an example autonomous artificial intelligence agent computing device in accordance with some embodiments of the present disclosure;

FIG. 4A and FIG. 4B illustrate an example machine learning model based hydrogen production management method that provides various technical improvements and advantages in accordance with some embodiments of the present disclosure;

FIG. 5 illustrates an example machine learning model based hydrogen production management method that provides various technical improvements and advantages in accordance with some embodiments of the present disclosure;

FIG. 6 illustrates an example machine learning model based hydrogen production management method that provides various technical improvements and advantages in accordance with some embodiments of the present disclosure; and

FIG. 7 illustrates an example machine learning model based hydrogen production management method that provides various technical improvements and advantages in accordance with some embodiments of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The term “electronically coupled,” “electronically coupling,” “electronically couple,” “in communication with,” “in electronic communication with,” or “connected” in the present disclosure refers to two or more elements or components being connected through wired means and/or wireless means, such that signals, electrical voltage/current, data and/or information may be transmitted to and/or received from these elements or components.

As described above, there are many technical challenges and difficulties associated with manufacturing devices, systems, and methods for hydrogen. Hydrogen is a flammable gas and can cause fires and explosions if it is not handled properly. However, many devices, systems, and methods fail to provide safety and reliability guarantees during the hydrogen manufacturing processes.

Various embodiments of the present disclosure overcome these technical challenges and difficulties, and provide various technical improvements and advantages. For example, various embodiments of the present disclosure implement one or more machine learning models that generate adjusted hydrogen production variable indicators, which can improve the safety and reliability when manufacturing hydrogen. Substitution of natural gas with hydrogen requires autonomous operations to bring down the cost of green hydrogen. Various embodiments of the present disclosure provide intelligent autonomous artificial intelligent agents (for example, intelligent hydrogen MES) that manage the source of electricity, the quantity to produce, where to store, and what to transport will bring down the cost while also improving safety through autonomous agents to fix known errors in the control process.

In the present disclosure, the term “data object” refers to a data structure that represents one or more functionalities and/or characteristics associated with data and/or information (for example, but not limited to, data and/or information associated with battery manufacturing). In some embodiments, a data object may be generated by a combination of one or more software (for example, one or more computer programs) and/or one or more hardware (for example, one or more servers and/or one or more client devices). In some embodiments, a data object may provide a functional unit for one or more computer programs.

In the present disclosure, the term “indicator” refers to digital data that may describe or is associated with one or more attributes and/or one or more data fields associated with a system (such as, but not limited to, a hydrogen manufacturing system as described herein).

In the present disclosure, the term “hydrogen production facility” refers to a facility (such as, but not limited to, a manufacturing plant) that produces hydrogen based on raw materials such as, but not limited to, natural gasses.

In the present disclosure, the term “hydrogen production control system” refers to a computer-implemented system that controls various processes and/or operations associated with the production of hydrogen in a hydrogen production facility.

In the present disclosure, the term “runtime hydrogen production variable indicator” refers to an indicator that represents, indicates, and/or comprises one or more hydrogen production operation parameter values or variables associated with a hydrogen production operation during run time. In some embodiments, the runtime hydrogen production variable indicator may be in the form of text string(s), numerical character(s), alphabetical character(s), alphanumeric code(s), ASCII character(s), and/or the like.

In some embodiments, example runtime hydrogen production variable indicators may be associated with different types. Example types of runtime hydrogen production variable indicators may include, but are not limited to, production power source variable indicators, hydrogen production quantity variable indicators, hydrogen storage location variable indicators, and hydrogen transport plan variable indicators.

In the present disclosure, the term “production power source variable indicator” refers to an indicator that represents, indicates, and/or comprises data and/or information associated with the power source that is used by the hydrogen production facility in producing the hydrogen. In some embodiments, the production power source variable indicator may be in the form of text string(s), numerical character(s), alphabetical character(s), alphanumeric code(s), ASCII character(s), and/or the like.

In the present disclosure, the term “hydrogen production quantity variable indicator” refers to an indicator that represents, indicates, and/or comprises data and/or information associated with the quantity of the hydrogen that is produced by the hydrogen production facility. In some embodiments, the hydrogen production quantity variable indicator may be in the form of text string(s), numerical character(s), alphabetical character(s), alphanumeric code(s), ASCII character(s), and/or the like.

In the present disclosure, the term “hydrogen storage location variable indicator” refers to an indicator that represents, indicates, and/or comprises data and/or information associated with the storage location of the hydrogen produced by the hydrogen production facility. In some embodiments, the hydrogen storage location variable indicator may be in the form of text string(s), numerical character(s), alphabetical character(s), alphanumeric code(s), ASCII character(s), and/or the like.

In the present disclosure, the term “hydrogen transport plan variable indicator” refers to an indicator that represents, indicates, and/or comprises data and/or information associated with the mechanism for transporting the hydrogen produced by the hydrogen production facility. In some embodiments, the hydrogen transport plan variable indicator may be in the form of text string(s), numerical character(s), alphabetical character(s), alphanumeric code(s), ASCII character(s), and/or the like.

While the description above provides example types of runtime hydrogen production variable indicators that include hydrogen production power source variable indicators, hydrogen production quantity variable indicators, hydrogen storage location variable indicators, and hydrogen transport plan variable indicators, it is noted that the scope of the present disclosure is not limited to the description above. In some examples, an example runtime hydrogen production variable indicator may comprise one or more additional and/or alternative types.

In the present disclosure, the term “adjusted hydrogen production variable indicator” refers to an indicator that represents, indicates, and/or comprises data and/or information associated with a hydrogen production variable indicator that has been adjusted in accordance with various example embodiments described herein. In some embodiments, the adjusted hydrogen production variable indicator may be in the form of text string(s), numerical character(s), alphabetical character(s), alphanumeric code(s), ASCII character(s), and/or the like.

In the present disclosure, the term “historical hydrogen production variable indicator” refers to an indicator that represents, indicates, and/or comprises one or more hydrogen production operation parameter values or variables associated with a hydrogen production operation during a past time period. In some embodiments, the historical hydrogen production variable indicator may be in the form of text string(s), numerical character(s), alphabetical character(s), alphanumeric code(s), ASCII character(s), and/or the like.

In the present disclosure, the term “hydrogen production machine learning model” refers to a machine learning model that is trained to generate one or more predicted hydrogen production operation indicators as one or more outputs in response to receiving the plurality of runtime hydrogen production variable indicators as one or more inputs.

In the present disclosure, the term “predicted hydrogen production operation indicator” refers to an indicator that represents, indicates, and/or comprises data and/or information associated with one or more predicted operation and performance levels associated with the hydrogen production facility in producing hydrogen. In some embodiments, the predicted hydrogen production operation indicator may be in the form of text string(s), numerical character(s), alphabetical character(s), alphanumeric code(s), ASCII character(s), and/or the like.

In some embodiments, predicted hydrogen production operation indicators may be associated with different types. For example, example types of predicted hydrogen production operation indicators may include, but are not limited to, predicted hydrogen production safety indicators, predicted hydrogen production cost indicators, and/or the like.

For example, an example hydrogen production machine learning model may comprise supervised machine learning algorithms. Examples of supervised machine learning algorithms may include, but are not limited to, classification models (such as, but not limited to, decision tree, random forest, and/or the like), regression models (such as, but not limited to, linear regression, logistic regression), and/or the like. In such an example, the hydrogen production machine learning model may be trained under supervision by using one or more labeled datasets that comprise one or more runtime hydrogen production variable indicators and their corresponding known predicted hydrogen production operation indicators. During supervised training, the example hydrogen production machine learning model may receive runtime hydrogen production variable indicators from the one or more labeled datasets as inputs, and may adjust one or more parameters of its machine learning algorithms such that the predicted hydrogen production operation indicators from the example hydrogen production machine learning model match the predicted hydrogen production operation indicators in the one or more labeled datasets.

As another example, an example hydrogen production machine learning model may comprise unsupervised machine learning algorithms. Examples of unsupervised machine learning algorithms may include, but are not limited to, clustering models (such as, but not limited to, K-means clustering, hierarchical clustering, and/or the like), association models (such as, but not limited to, Apriori algorithm), and/or the like. In such an example, the hydrogen production machine learning model may be trained by receiving one or more runtime hydrogen production variable indicators as an unlabeled dataset and identifying one or more patterns from the one or more runtime hydrogen production variable indicators to generate one or more predicted hydrogen production operation indicators as the outputs.

While the description above provides examples of hydrogen production machine learning model, it is noted that the scope of the present disclosure is not limited to the description above. In some examples, an example hydrogen production machine learning model may comprise one or more additional and/or alternative machine learning models. For example, an example hydrogen production machine learning model may additionally or alternatively comprise support vector machine models, naive bayes models, artificial neural networks, and/or the like.

In the present disclosure, the term “hydrogen production safety prediction machine learning model” refers to a machine learning model that is trained to generate one or more predicted hydrogen production safety indicators as one or more outputs in response to receiving one or more runtime hydrogen production variable indicators as one or more inputs.

For example, an example hydrogen production safety prediction machine learning model may comprise supervised machine learning algorithms. Examples of supervised machine learning algorithms may include, but are not limited to, classification models (such as, but not limited to, decision tree, random forest, and/or the like), regression models (such as, but not limited to, linear regression, logistic regression), and/or the like. In such an example, the hydrogen production safety prediction machine learning model may be trained under supervision by using one or more labeled datasets that comprise one or more runtime hydrogen production variable indicators and their corresponding known predicted hydrogen production safety indicators. During supervised training, the example hydrogen production safety prediction machine learning model may receive runtime hydrogen production variable indicators from the one or more labeled datasets as inputs, and may adjust one or more parameters of its machine learning algorithms such that the predicted hydrogen production safety indicators from the example hydrogen production safety prediction machine learning model match the predicted hydrogen production safety indicators in the one or more labeled datasets.

As another example, an example hydrogen production safety prediction machine learning model may comprise unsupervised machine learning algorithms. Examples of unsupervised machine learning algorithms may include, but are not limited to, clustering models (such as, but not limited to, K-means clustering, hierarchical clustering, and/or the like), association models (such as, but not limited to, Apriori algorithm), and/or the like. In such an example, the hydrogen production safety prediction machine learning model may be trained by receiving one or more runtime hydrogen production variable indicators as an unlabeled dataset and identifying one or more patterns from the one or more runtime hydrogen production variable indicators to generate one or more predicted hydrogen production safety indicators as the outputs.

While the description above provides examples of hydrogen production safety prediction machine learning model, it is noted that the scope of the present disclosure is not limited to the description above. In some examples, an example hydrogen production safety prediction machine learning model may comprise one or more additional and/or alternative machine learning models. For example, an example hydrogen production safety prediction machine learning model may additionally or alternatively comprise support vector machine models, naive bayes models, artificial neural networks, and/or the like.

In the present disclosure, the term “predicted hydrogen production safety indicator” refers to an indicator that represents, indicates, and/or comprises data and/or information associated with a predicted safety level associated with producing hydrogen by the hydrogen production facility. In some embodiments, the predicted hydrogen production safety indicator may be in the form of text string(s), numerical character(s), alphabetical character(s), alphanumeric code(s), ASCII character(s), and/or the like.

In the present disclosure, the term “historical hydrogen production safety indicator” refers to an indicator that represents, indicates, and/or comprises data and/or information associated with the safety level of producing hydrogen in the past. In some embodiments, the historical hydrogen production safety indicator may be in the form of text string(s), numerical character(s), alphabetical character(s), alphanumeric code(s), ASCII character(s), and/or the like.

In the present disclosure, the term “hydrogen production cost prediction machine learning model” refers to a machine learning model that is trained to generate one or more predicted hydrogen production cost indicators as one or more outputs in response to receiving one or more runtime hydrogen production variable indicators as one or more inputs.

For example, an example hydrogen production cost prediction machine learning model may comprise supervised machine learning algorithms. Examples of supervised machine learning algorithms may include, but are not limited to, classification models (such as, but not limited to, decision tree, random forest, and/or the like), regression models (such as, but not limited to, linear regression, logistic regression), and/or the like. In such an example, the hydrogen production cost prediction machine learning model may be trained under supervision by using one or more labeled datasets that comprise one or more runtime hydrogen production variable indicators and their corresponding known predicted hydrogen production cost indicators. During supervised training, the example hydrogen production cost prediction machine learning model may receive runtime hydrogen production variable indicators from the one or more labeled datasets as inputs, and may adjust one or more parameters of its machine learning algorithms such that the predicted hydrogen production cost indicators from the example hydrogen production cost prediction machine learning model match the predicted hydrogen production cost indicators in the one or more labeled datasets.

As another example, an example hydrogen production cost prediction machine learning model may comprise unsupervised machine learning algorithms. Examples of unsupervised machine learning algorithms may include, but are not limited to, clustering models (such as, but not limited to, K-means clustering, hierarchical clustering, and/or the like), association models (such as, but not limited to, Apriori algorithm), and/or the like. In such an example, the hydrogen production cost prediction machine learning model may be trained by receiving one or more runtime hydrogen production variable indicators as an unlabeled dataset and identifying one or more patterns from the one or more runtime hydrogen production variable indicators to generate one or more predicted hydrogen production cost indicators as the outputs.

While the description above provides examples of hydrogen production cost prediction machine learning model, it is noted that the scope of the present disclosure is not limited to the description above. In some examples, an example hydrogen production cost prediction machine learning model may comprise one or more additional and/or alternative machine learning models. For example, an example hydrogen production cost prediction machine learning model may additionally or alternatively comprise support vector machine models, naive bayes models, artificial neural networks, and/or the like.

In the present disclosure, the term “predicted hydrogen production cost indicator” refers to an indicator that represents, indicates, and/or comprises data and/or information associated with a predicted cost associated with producing hydrogen by the hydrogen production facility. In some embodiments, the predicted hydrogen production cost indicator may be in the form of text string(s), numerical character(s), alphabetical character(s), alphanumeric code(s), ASCII character(s), and/or the like.

In the present disclosure, the term “historical hydrogen production cost indicator” refers to an indicator that represents, indicates, and/or comprises data and/or information associated with the cost of producing hydrogen in the past. In some embodiments, the historical hydrogen production cost indicator may be in the form of text string(s), numerical character(s), alphabetical character(s), alphanumeric code(s), ASCII character(s), and/or the like.

In the present disclosure, the term “hydrogen production operation threshold indicator” refers to an indicator that represents, indicates, and/or comprises data and/or information associated with a threshold value for a predicted hydrogen production operation indicator. For example, an example hydrogen production operation threshold indicator may be associated with predicted hydrogen production safety indicators. Additionally, or alternatively, an example hydrogen production operation threshold indicator may be associated with predicted hydrogen production cost indicators.

In some embodiments, if the predicted hydrogen production operation indicator does not satisfy the corresponding hydrogen production operation threshold indicator, the hydrogen production facility is predicted to be at a high risk of deteriorated performance (for example, operating at a higher cost and/or a low safety level). In some embodiments, if the predicted hydrogen production operation indicator satisfies the corresponding hydrogen production operation threshold indicator, the hydrogen production facility is predicted to be at a low risk of deteriorated performance (for example, operating at a reduced cost and/or a high safety level).

In some embodiments, the hydrogen production operation threshold indicator may be in the form of text string(s), numerical character(s), alphabetical character(s), alphanumeric code(s), ASCII character(s), and/or the like.

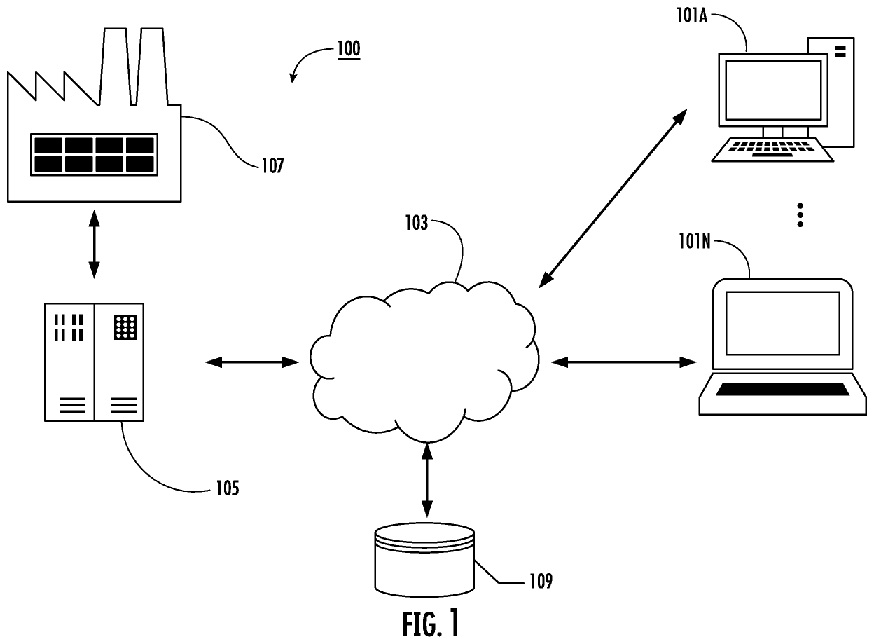

Referring now to FIG. 1, an example system architecture diagram illustrates an example intelligent autonomous hydrogen production management system 100 in accordance with some embodiments of the present disclosure.

In the example shown in FIG. 1, the example intelligent autonomous hydrogen production management system 100 comprises a hydrogen production facility 107, an hydrogen production control system 105, one or more autonomous artificial intelligence agent computing devices (such as, but not limited to, the autonomous artificial intelligence agent computing device 101A, . . . the autonomous artificial intelligence agent computing device 101N), one or more data repository (such as, but not limited to, the data repository 109).

In some embodiments, the hydrogen production facility 107 may be in the form of a manufacturing plant or factory that produces hydrogen. For example, the hydrogen production facility 107 may carry out one or more processes and operations (such as, but not limited to, one or more manufacturing processes/operations) associated with hydrogen production. In some embodiments, runtime hydrogen production variable indicators associated with the hydrogen production by the hydrogen production facility 107 are generated and provided to the hydrogen production control system 105.

In some embodiments, the plurality of runtime hydrogen production variable indicators comprises a production power source variable indicator associated with the hydrogen production facility 107, a hydrogen production quantity variable indicator associated with the hydrogen production facility 107, a hydrogen storage location variable indicator associated with the hydrogen production facility 107, and/or a hydrogen transport plan variable indicator associated with the hydrogen production facility 107. Additionally, or alternatively, the plurality of runtime hydrogen production variable indicators comprises other types of runtime hydrogen production variable indicators.

In some embodiments, the hydrogen production control system 105 transmits the runtime hydrogen production variable indicators to the one or more autonomous artificial intelligence agent computing devices (such as, but not limited to, the autonomous artificial intelligence agent computing device 101A, . . . the autonomous artificial intelligence agent computing device 101N) through the communication network 103.

In one embodiment, the communication network 103 may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the communication network 103 may have any suitable communication range associated therewith and may include, for example, global networks (e.g., the Internet), MANs, WANs, LANs, or PANs. In addition, the communication network 103 may include medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms/systems provided by network providers or other entities.

Further, the communication network 103 may utilize a variety of networking protocols including, but not limited to, TCP/IP based networking protocols. In some embodiments, the protocol is a custom protocol of JavaScript Object Notation (JSON) objects sent via a WebSocket channel. In some embodiments, the protocol is JSON over RPC, JSON over REST/HTTP, and/or the like.

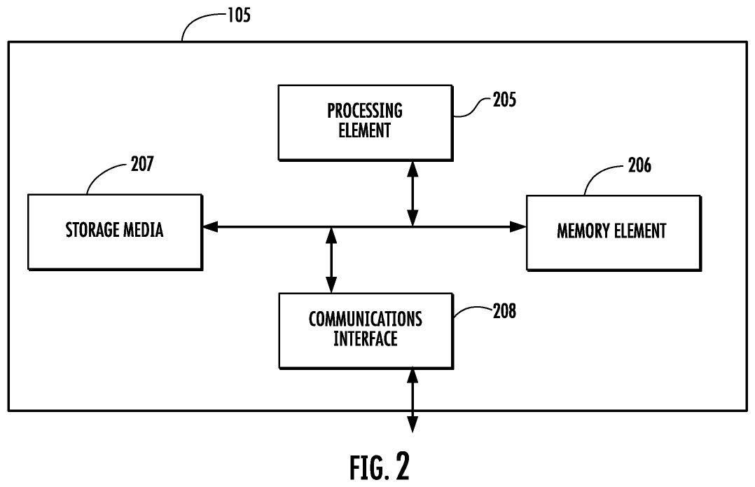

FIG. 2 provides a schematic of an hydrogen production control system 105 according to one embodiment of the present disclosure. In general, the terms computing entity, entity, device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein.

As indicated, in one embodiment, the hydrogen production control system 105 may also include one or more network and/or communications interface 208 for communicating with various computing entities, such as by communicating data, content, information, and/or similar terms used herein that can be transmitted, received, operated on, processed, displayed, stored, and/or the like.

As shown in FIG. 2, in one embodiment, the hydrogen production control system 105 may include or be in communication with one or more processing elements (for example, processing element 205) (also referred to as processors, processing circuitry, and/or similar terms used herein interchangeably) that communicate with other elements within the hydrogen production control system 105 via a bus, for example, or network connection. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

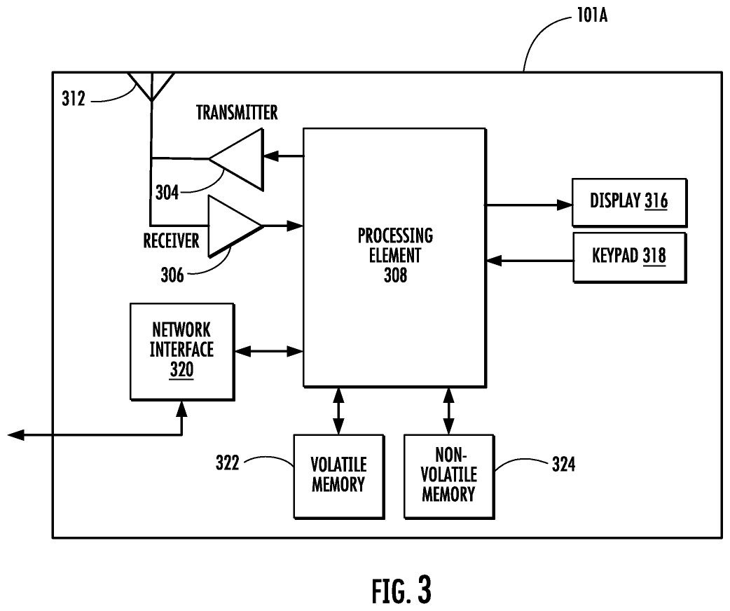

In one embodiment, the hydrogen production control system 105 may further include or be in communication with volatile media (also referred to as volatile storage, memory, memory storage, memory circuitry and/or similar terms used herein interchangeably). In one embodiment, the volatile storage or memory may also include one or more memory element 206 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory element 206 may be used to store at least portions of the databases, database instances, database management system entities, data, applications, programs, program modules, scripts, source code, object code, byte code, compiled code, interpreted code, machine code, executable instructions, and/or the like being executed by, for example, the processing element 205 as shown in FIG. 2 and/or the processing element 308 as described in connection with FIG. 3. Thus, the databases, database instances, database management system entities, data, applications, programs, program modules, scripts, source code, object code, byte code, compiled code, interpreted code, machine code, executable instructions, and/or the like may be used to control certain aspects of the operation of the hydrogen production control system 105 with the assistance of the processing element 205 and operating system.

In one embodiment, the hydrogen production control system 105 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or storage media 207 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or storage media 207 may store databases, database instances, database management system entities, data, applications, programs, program modules, scripts, source code, object code, byte code, compiled code, interpreted code, machine code, executable instructions, and/or the like. The term database, database instance, database management system entity, and/or similar terms used herein interchangeably and in a general sense to may refer to a structured or unstructured collection of information/data that is stored in a computer-readable storage medium.

Storage media 207 may also be embodied as a data storage device or devices, as a separate database server or servers, or as a combination of data storage devices and separate database servers. Further, in some embodiments, storage media 207 may be embodied as a distributed repository such that some of the stored information/data is stored centrally in a location within the system and other information/data is stored in one or more remote locations. Alternatively, in some embodiments, the distributed repository may be distributed over a plurality of remote storage locations only. An example of the embodiments contemplated herein would include a cloud data storage system maintained by a third-party provider and where some or all of the information/data required for the operation of the recovery system may be stored. Further, the information/data required for the operation of the recovery system may also be partially stored in the cloud data storage system and partially stored in a locally maintained data storage system. More specifically, storage media 207 may encompass one or more data stores configured to store information/data usable in certain embodiments.

As indicated, in one embodiment, the hydrogen production control system 105 may also include one or more network and/or communications interface 208 for communicating with various computing entities, such as by communicating data, content, information, and/or similar terms used herein interchangeably that can be transmitted, received, operated on, processed, displayed, stored, and/or the like. For instance, the hydrogen production control system 105 may communicate with computing entities or communication interfaces.

As indicated, in one embodiment, the hydrogen production control system 105 may also include one or more network and/or communications interface 208 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the hydrogen production control system 105 may be configured to communicate via wireless external communication networks using any of a variety of protocols, such as general packet radio service (GPRS), Universal Mobile Telecommunications System (UMTS), Code Division Multiple Access 1900 (CDMA1900), CDMA1900 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), Institute of Electrical and Electronics Engineers (IEEE) 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The hydrogen production control system 105 may usc such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

FIG. 3 provides an illustrative schematic representative of one of autonomous artificial intelligence agent computing devices 101A to 101N that can be used in conjunction with embodiments of the present disclosure. As will be recognized, an autonomous artificial intelligence agent computing device may be operated by an agent and include components and features similar to those described in conjunction with the autonomous artificial intelligence agent computing device 101A. Further, as shown in FIG. 3, autonomous artificial intelligence agent computing devices may include additional components and features. For example, autonomous artificial intelligence agent computing device 101A can include an antenna 312, a transmitter 304 (e.g., radio), a receiver 306 (e.g., radio), and a processing element 308 that provides signals to and receives signals from the transmitter 304 and receiver 306, respectively. The signals provided to and received from the transmitter 304 and the receiver 306, respectively, may include signaling information/data in accordance with an air interface standard of applicable wireless systems to communicate with various entities. In this regard, autonomous artificial intelligence agent computing device 101A may be capable of operating with one or more air interface standards, communication protocols, modulation types, and access types. More particularly, autonomous artificial intelligence agent computing device 101A may comprise a network interface 320, and may operate in accordance with any of a number of wireless communication standards and protocols. In a particular embodiment, autonomous artificial intelligence agent computing device 101A may operate in accordance with multiple wireless communication standards and protocols, such as GPRS, UMTS, CDMA1900, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, autonomous artificial intelligence agent computing device 101A can communicate with various other entities using Unstructured Supplementary Service data (USSD), Short Message Service (SMS), Multimedia Messaging Service (MMS), Dual-Tone Multi-Frequency (DTMF) Signaling, Subscriber Identity Module Dialer (SIM dialer), and/or the like. Autonomous artificial intelligence agent computing device 101A can also download changes, add-ons, and updates, for instance, to its firmware, software (e.g., including executable instructions, applications, program modules), and operating system.

According to one embodiment, autonomous artificial intelligence agent computing device 101A may include location determining aspects, devices, modules, functionalities, and/or similar words used herein interchangeably. For example, autonomous artificial intelligence agent computing device 101A may include outdoor positioning aspects, such as a location module adapted to acquire, for example, latitude, longitude, altitude, geocode, course, direction, heading, speed, UTC, date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information/data/data may be determined by triangulating the position in connection with a variety of other systems, including cellular towers, Wi-Fi access points, and/or the like. Similarly, autonomous artificial intelligence agent computing device 101A may include indoor positioning aspects, such as a location module adapted to acquire, for example, latitude, longitude, altitude, geocode, course, direction, heading, speed, time, date, and/or various other information/data. Some of the indoor aspects may use various position or location technologies including Radio-Frequency Identification (RFID) tags, indoor beacons or transmitters, Wi-Fi access points, cellular towers, nearby computing devices (e.g., smartphones, laptops) and/or the like. For instance, such technologies may include iBeacons, Gimbal proximity beacons, Bluetooth Low Energy (BLE) transmitters, Near Field Communication (NFC) transmitters, and/or the like. These indoor positioning aspects can be used in a variety of settings to determine the location of someone or something to within inches or centimeters.

Autonomous artificial intelligence agent computing device 101A may also comprise a user interface comprising one or more user input/output interfaces (e.g., a display 316 and/or speaker/speaker driver coupled to a processing element 308 and a touch screen, keyboard, mouse, and/or microphone coupled to a processing element 308). For example, the user output interface may be configured to provide an application, browser, user interface, dashboard, webpage, and/or similar words used herein interchangeably executing on and/or accessible via autonomous artificial intelligence agent computing device 101A to cause display or audible presentation of information/data and for user interaction therewith via one or more user input interfaces. The user input interface can comprise any of a number of devices allowing autonomous artificial intelligence agent computing device 101A to receive data, such as a keypad 318 (hard or soft), a touch display, voice/speech or motion interfaces, scanners, readers, or other input device. In embodiments including a keypad 318, the keypad 318 can include (or cause display of) the conventional numeric (0-9) and related keys (#, *), and other keys used for operating the autonomous artificial intelligence agent computing device 101A and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs, the autonomous artificial intelligence agent computing device 101A can collect information/data, user interaction/input, and/or the like.

Autonomous artificial intelligence agent computing device 101A can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of autonomous artificial intelligence agent computing devices 101A-101N.

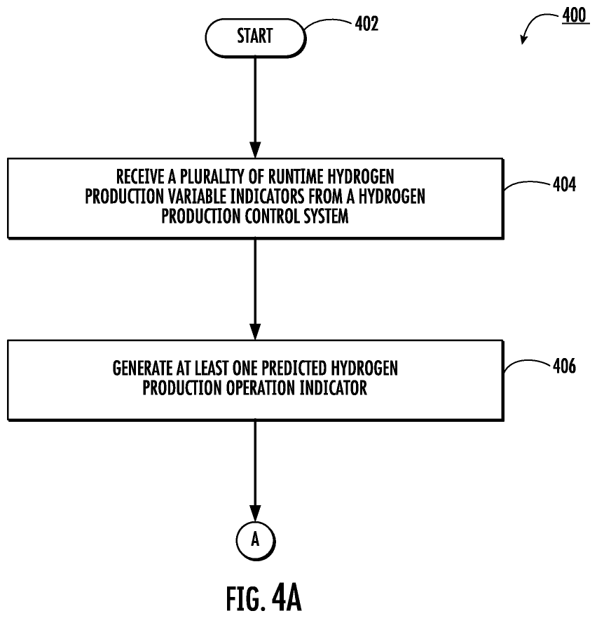

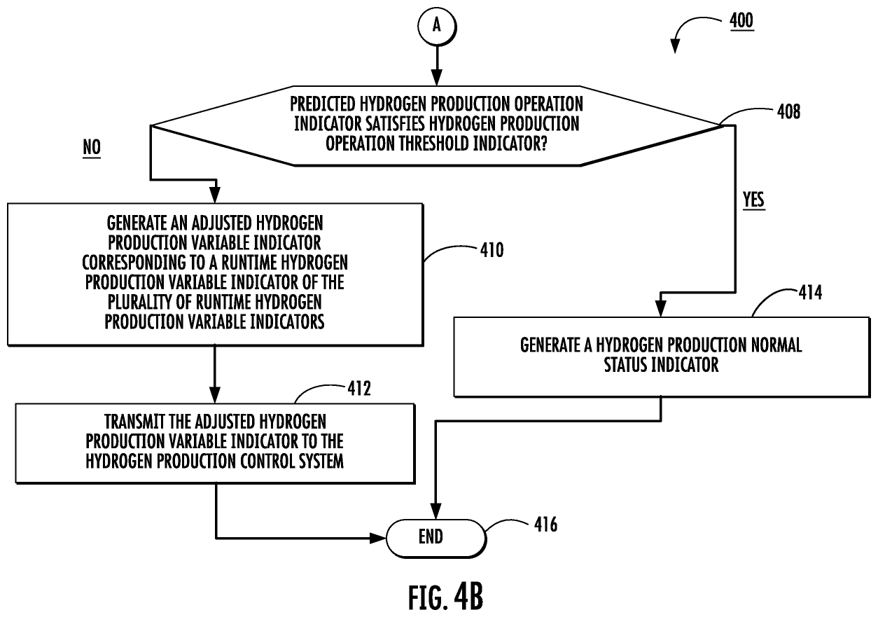

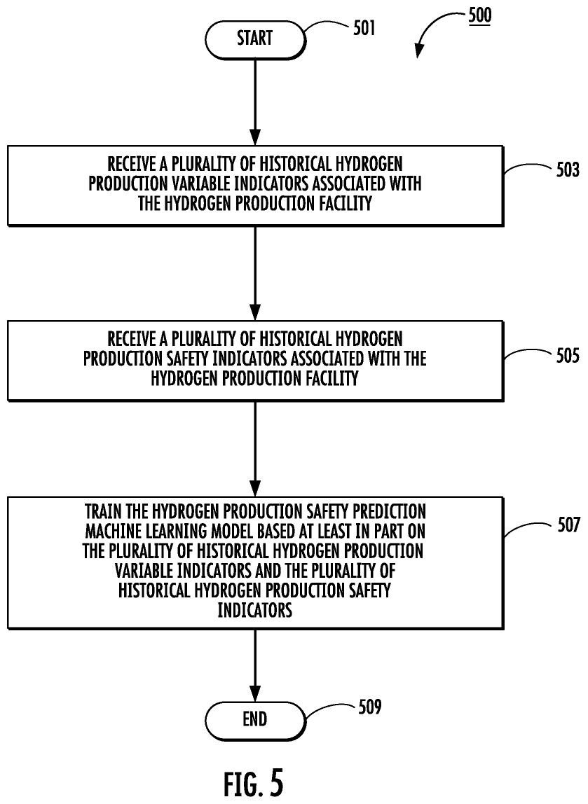

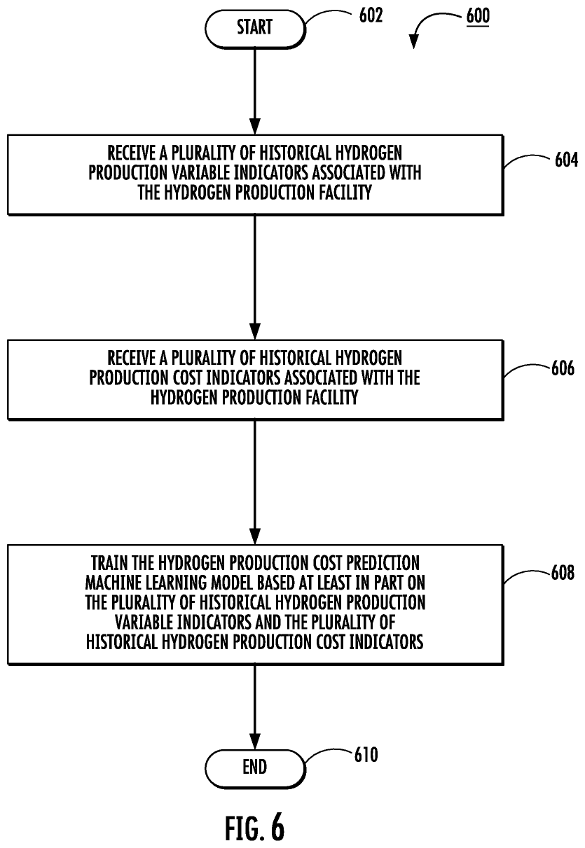

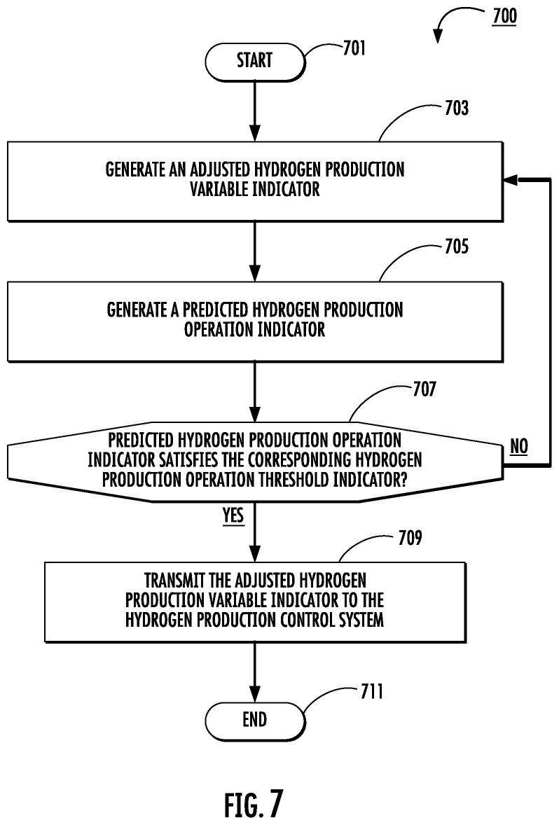

Reference will now be made to FIG. 4A, FIG. 4B, FIG. 5, FIG. 6, and FIG. 7, which provide flowcharts and diagrams illustrating example steps, processes, procedures, and/or operations associated with various embodiments of the present disclosure.

Embodiments of the present disclosure may be implemented as computer program products that comprise articles of manufacture. Such computer program products may include one or more software components including, for example, applications, software objects, methods, data structures, and/or the like. A software component may be coded in any of a variety of programming languages. An illustrative programming language may be a lower-level programming language such as an assembly language associated with a particular hardware architecture and/or operating system platform/system. A software component comprising assembly language instructions may require conversion into executable machine code by an assembler prior to execution by the hardware architecture and/or platform/system. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Additionally, or alternatively, embodiments of the present disclosure may be implemented as a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media may include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatuses, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Referring now to FIG. 4A, and FIG. 4B, an example machine learning model based hydrogen production management method 400 that provides various technical improvements and advantages in accordance with some embodiments of the present disclosure is illustrated.

In the example shown in FIG. 4A, the example method 400 starts at step/operation 402. In some embodiments, subsequent to and/or response to step/operation 402, the example method 400 proceeds to step/operation 404. At step/operation 404, a computing device (such as, but not limited to, the example autonomous artificial intelligence agent computing device described and illustrated above in connection with FIG. 1 and FIG. 2) may receive a plurality of runtime hydrogen production variable indicators from a hydrogen production control system.

As described above, each of the plurality of runtime hydrogen production variable indicators indicates one or more hydrogen production operation parameter values or variables associated with a hydrogen production operation during run time. For example, the plurality of runtime hydrogen production variable indicators may comprise one or more production power source variable indicators, one or more hydrogen production quantity variable indicators, one or more hydrogen storage location variable indicators, and/or one or more hydrogen transport plan variable indicators. Additionally, or alternatively, the plurality of runtime hydrogen production variable indicators may comprise one or more other types of hydrogen production quantity variable indicators.

Referring back to FIG. 4A, subsequent to and/or response to step/operation 404, the example method 400 proceeds to step/operation 406. At step/operation 406, a computing device (such as, but not limited to, the example autonomous artificial intelligence agent computing device described and illustrated above in connection with FIG. 1 and FIG. 2) may generate at least one predicted hydrogen production operation indicator.

In some embodiments, the computing device generates the at least one predicted hydrogen production operation indicator based at least in part on inputting the plurality of runtime hydrogen production variable indicators to one or more hydrogen production machine learning models.

For example, the one or more hydrogen production machine learning models may comprise a hydrogen production safety prediction machine learning model that generates predicted hydrogen production operation indicators in the forms of predicted hydrogen production safety indicators. Additional details associated with the hydrogen production safety prediction machine learning model and the predicted hydrogen production safety indicators are described herein, including, but not limited to, those described in connection with at least FIG. 5.

Additionally, or alternatively, the one or more hydrogen production machine learning models may comprise a hydrogen production cost prediction machine learning model that generates predicted hydrogen production operation indicators in the forms of predicted hydrogen production cost indicators. Additional details associated with the hydrogen production cost prediction machine learning model and the predicted hydrogen production cost indicators are described herein, including, but not limited to, those described in connection with at least FIG. 6.

As described above, various embodiments of the present disclosure provide various technical improvements to various technologies and technological fields such as, but not limited to, the field of hydron manufacturing. For example, by generating predicted hydrogen production operation indicators, various embodiments may proactively predict the operation outcome of hydron manufacturing while reducing the likelihood of critical errors or failures during hydron manufacturing.

Referring back to FIG. 4A, subsequent to and/or response to step/operation 406, the example method 400 proceeds to block A, which connects FIG. 4A to FIG. 4B. Referring now to FIG. 4B, subsequent to and/or response to block A (for example, subsequent to and/or response to step/operation 406 shown in FIG. 4A), the example method 400 proceeds to step/operation 408. At step/operation 408, a computing device (such as, but not limited to, the example autonomous artificial intelligence agent computing device described and illustrated above in connection with FIG. 1 and FIG. 2) may determine whether the predicted hydrogen production operation indicator satisfies the hydrogen production operation threshold indicator.

In some embodiments, the hydrogen production operation threshold indicator corresponds to the predicted hydrogen production operation indicator and is associated with the hydrogen production facility. For example, if the predicted hydrogen production operation indicator is in the form of a predicted hydrogen production safety indicator, the computing device determines whether the predicted hydrogen production safety indicator satisfies a hydrogen production operation threshold indicator that is associated with the predicted hydrogen production safety indicator. Additionally, or alternatively, if the predicted hydrogen production operation indicator is in the form of a predicted hydrogen production cost indicator, the computing device determines whether the predicted hydrogen production cost indicator satisfies a hydrogen production operation threshold indicator that is associated with the predicted hydrogen production cost indicator.

In some embodiments, the hydrogen production operation threshold indicator may be determined based on one or more user inputs. In some embodiments, the hydrogen production operation threshold indicator may be determined based on one or more systems settings associated with the hydrogen production facility.

If, at step/operation 408, the computing device determines that the predicted hydrogen production operation indicator does not satisfy the hydrogen production operation threshold indicator, the example method 400 proceeds step/operation 410. At step/operation 410, a computing device (such as, but not limited to, the example autonomous artificial intelligence agent computing device described and illustrated above in connection with FIG. 1 and FIG. 2) may generate an adjusted hydrogen production variable indicator corresponding to a runtime hydrogen production variable indicator of the plurality of runtime hydrogen production variable indicators.

For example the computing device may generate an adjusted hydrogen production variable indicator as a replacement of the runtime hydrogen production variable indicator received at step/operation 404. In some embodiments, the adjusted hydrogen production variable indicator may present, indicate, and/or comprise one or more adjustments associated with the runtime hydrogen production variable indicator.

Referring back to FIG. 4B, subsequent to and/or response to step/operation 410, the example method 400 proceeds to step/operation 412. At step/operation 412, a computing device (such as, but not limited to, the example autonomous artificial intelligence agent computing device described and illustrated above in connection with FIG. 1 and FIG. 2) may transmit the adjusted hydrogen production variable indicator to the hydrogen production control system.

For example, as described above in connection with FIG. 1, the example autonomous artificial intelligence agent computing devices 101A may be in data communications with the hydrogen production control system 105 via the communication network 103. In such an example, the example autonomous artificial intelligence agent computing devices 101A may transmit the adjusted hydrogen production variable indicator to the hydrogen production control system 105 via the communication network 103.

In some embodiments, upon receiving the adjusted hydrogen production variable indicator, the hydrogen production control system 105 may adjust the corresponding hydrogen production variable indicator. For example, the hydrogen production control system 105 may modify one or more processes and/or operations associated with the hydrogen production facility 107 in producing hydrogen.

Referring back to FIG. 4B, subsequent to and/or response to step/operation 412, the example method 400 proceeds to step/operation 416 and ends.

If, at step/operation 408, the computing device determines that the predicted hydrogen production operation indicator satisfies the hydrogen production operation threshold indicator, the example method 400 proceeds step/operation 414. At step/operation 414, a computing device (such as, but not limited to, the example autonomous artificial intelligence agent computing device described and illustrated above in connection with FIG. 1 and FIG. 2) may generate a hydrogen production normal status indicator.

For example, the hydrogen production normal status indicator may indicate that processes and/or operations associated with the hydrogen production facility are normal, and/or that no adjustments are needed. In some embodiments, the computing device may render the hydrogen production normal status indicator on a display.

As described above, various embodiments of the present disclosure provide various technical improvements to various technologies and technological fields such as, but not limited to, the field of hydron manufacturing. For example, by comparing the predicted hydrogen production operation indicator with the hydrogen production operation threshold indicator, various embodiments of the present disclosure may proactively predict the operation status of the hydrogen production facility, reduce the likelihood of critical errors or failures during hydrogen manufacturing, and improve the safety level in hydrogen manufacturing.

Referring back to FIG. 4B, subsequent to and/or response to step/operation 414, the example method 400 proceeds to step/operation 416 and ends.

Referring now to FIG. 5, an example machine learning model based hydrogen production management method 500 that provides various technical improvements and advantages in accordance with some embodiments of the present disclosure is illustrated.

As described above, in some embodiments, predicted hydrogen production operation indicators in accordance with some embodiments of the present disclosure may comprise a predicted hydrogen production safety indicator. In such examples, the one or more hydrogen production machine learning models comprise a hydrogen production safety prediction machine learning model that generates the predicted hydrogen production safety indicator. The example method 500 illustrates example processes and/or operations associated with training a hydrogen production safety prediction machine learning model in accordance with some embodiments of the present disclosure.

In the example shown in FIG. 5, the example method 500 starts at step/operation 501. In some embodiments, subsequent to and/or response to step/operation 501, the example method 500 proceeds to step/operation 503. At step/operation 503, a computing device (such as, but not limited to, the example autonomous artificial intelligence agent computing device described and illustrated above in connection with FIG. 1 and FIG. 2) may receive a plurality of historical hydrogen production variable indicators associated with the hydrogen production facility.

As described above, the historical hydrogen production variable indicators comprise hydrogen production operation parameter values or variables associated with a hydrogen production operation during a past time period.

Referring back to FIG. 5, subsequent to and/or response to step/operation 503, the example method 500 proceeds to step/operation 505. At step/operation 505, a computing device (such as, but not limited to, the example autonomous artificial intelligence agent computing device described and illustrated above in connection with FIG. 1 and FIG. 2) may receive a plurality of historical hydrogen production safety indicators associated with the hydrogen production facility.

As described above, the historical hydrogen production safety indicator represents, indicates, and/or comprises data and/or information associated with the safety level of producing hydrogen during a past time period. For example, the historical hydrogen production safety indicator may be generated based at least in part on one or more user inputs.

In some embodiments, the plurality of historical hydrogen production safety indicators and the plurality of historical hydrogen production variable indicators are associated with the same hydrogen production facility and the same time period.

Referring back to FIG. 5, subsequent to and/or response to step/operation 505, the example method 500 proceeds to step/operation 507. At step/operation 507, a computing device (such as, but not limited to, the example autonomous artificial intelligence agent computing device described and illustrated above in connection with FIG. 1 and FIG. 2) may train the hydrogen production safety prediction machine learning model based at least in part on the plurality of historical hydrogen production variable indicators and the plurality of historical hydrogen production safety indicators.

For example, the computing device may input the plurality of historical hydrogen production variable indicators to the hydrogen production safety prediction machine learning model as the training data set. In such an example, the hydrogen production safety prediction machine learning model may generate a plurality of training hydrogen production safety indicators. In some embodiments, the hydrogen production safety prediction machine learning model compares the plurality of training hydrogen production safety indicators and the plurality of historical hydrogen production safety indicators, and causes one or more adjustments to its parameters, such that the plurality of training hydrogen production safety indicators generated by the hydrogen production safety prediction machine learning model is as close to the plurality of historical hydrogen production safety indicators as possible.

As described above, various embodiments of the present disclosure provide various technical improvements to various technologies and technological fields such as, but not limited to, the field of hydrogen manufacturing. For example, by training the hydrogen production safety prediction machine learning model, various embodiments may improve the accuracy of predicting the safety level associated with the hydrogen manufacturing facility.

Referring back to FIG. 5, subsequent to and/or response to step/operation 507, the example method 500 proceeds to step/operation 509 and ends.

Referring now to FIG. 6, an example machine learning model based hydrogen production management method 600 that provides various technical improvements and advantages in accordance with some embodiments of the present disclosure is illustrated.

As described above, in some embodiments, predicted hydrogen production operation indicators in accordance with some embodiments of the present disclosure may comprise a predicted hydrogen production cost indicator. In such examples, the one or more hydrogen production machine learning models comprise a hydrogen production cost prediction machine learning model that generates the predicted hydrogen production cost indicator. The example method 600 illustrates example processes and/or operations associated with training a hydrogen production cost prediction machine learning model in accordance with some embodiments of the present disclosure.

In the example shown in FIG. 6, the example method 600 starts at step/operation 602. In some embodiments, subsequent to and/or response to step/operation 602, the example method 600 proceeds to step/operation 604. At step/operation 604, a computing device (such as, but not limited to, the example autonomous artificial intelligence agent computing device described and illustrated above in connection with FIG. 1 and FIG. 2) may receive a plurality of historical hydrogen production variable indicators associated with the hydrogen production facility.

As described above, the historical hydrogen production variable indicators comprise hydrogen production operation parameter values or variables associated with a hydrogen production operation during a past time period.

Referring back to FIG. 6, subsequent to and/or response to step/operation 604, the example method 600 proceeds to step/operation 606. At step/operation 606, a computing device (such as, but not limited to, the example autonomous artificial intelligence agent computing device described and illustrated above in connection with FIG. 1 and FIG. 2) may receive a plurality of historical hydrogen production cost indicators associated with the hydrogen production facility.

As described above, the historical hydrogen production cost indicator represents, indicates, and/or comprises data and/or information associated with the cost of producing hydrogen during a past time period. For example, the historical hydrogen production cost indicator may be generated based at least in part on one or more user inputs.

In some embodiments, the plurality of historical hydrogen production cost indicators and the plurality of historical hydrogen production variable indicators are associated with the same hydrogen production facility and the same time period.

Referring back to FIG. 6, subsequent to and/or response to step/operation 606, the example method 600 proceeds to step/operation 608. At step/operation 608, a computing device (such as, but not limited to, the example autonomous artificial intelligence agent computing device described and illustrated above in connection with FIG. 1 and FIG. 2) may train the hydrogen production cost prediction machine learning model based at least in part on the plurality of historical hydrogen production variable indicators and the plurality of historical hydrogen production cost indicators.

For example, the computing device may input the plurality of historical hydrogen production variable indicators to the hydrogen production cost prediction machine learning model as a training data set. In such an example, the hydrogen production cost prediction machine learning model may generate a plurality of training hydrogen production cost indicators. In some embodiments, the hydrogen production cost prediction machine learning model compares the plurality of training hydrogen production cost indicators and the plurality of historical hydrogen production cost indicators, and causes one or more adjustments to its parameters, such that the plurality of training hydrogen production cost indicators generated by the hydrogen production cost prediction machine learning model is as close to the plurality of historical hydrogen production cost indicators as possible.

As described above, various embodiments of the present disclosure provide various technical improvements to various technologies and technological fields such as, but not limited to, the field of hydrogen manufacturing. For example, by training the hydrogen production cost prediction machine learning model, various embodiments may improve the accuracy of predicting the cost associated with operating the hydrogen manufacturing facility.

Referring back to FIG. 6, subsequent to and/or response to step/operation 608, the example method 600 proceeds to step/operation 610 and ends.

Referring now to FIG. 7, an example machine learning model based hydrogen production management method 700 that provides various technical improvements and advantages in accordance with some embodiments of the present disclosure is illustrated. In particular, the example method 700 illustrates example processes and operations associated with determining whether to transmit or implement an adjusted hydrogen production variable indicator prior to transmitting or implementing the adjusted hydrogen production variable indicator.

In the example shown in FIG. 7, the example method 700 starts at step/operation 701. In some embodiments, subsequent to and/or response to step/operation 701, the example method 700 proceeds to step/operation 703. At step/operation 703, a computing device (such as, but not limited to, the example autonomous artificial intelligence agent computing device described and illustrated above in connection with FIG. 1 and FIG. 2) may generate an adjusted hydrogen production variable indicator.

In some embodiments, the computing device generates the adjusted hydrogen production variable indicator based at least in part on a plurality of runtime hydrogen production variable indicators and one or more machine learning models, similar to those described above in connection with at least FIG. 4A and FIG. 4B.

Referring back to FIG. 7, subsequent to and/or response to step/operation 703, the example method 700 proceeds to step/operation 705. At step/operation 705, a computing device (such as, but not limited to, the example autonomous artificial intelligence agent computing device described and illustrated above in connection with FIG. 1 and FIG. 2) may generate at least one predicted hydrogen production operation indicator.

For example, the plurality of runtime hydrogen production variable indicators may comprise the runtime hydrogen production variable indicator and one or more additional runtime hydrogen production variable indicators. In such an example, the adjusted hydrogen production variable indicator represents, indicates, and/or comprises one or more adjustments associated with the runtime hydrogen production variable indicator that are not associated with the one or more additional runtime hydrogen production variable indicators.

Continuing from the above example, the computing device may provide the adjusted hydrogen production variable indicator (instead of the runtime hydrogen production variable indicator) and the one or more additional runtime hydrogen production variable indicators to the one or more hydrogen production machine learning models. In response to receiving the inputs, the one or more hydrogen production machine learning models may generate a predicted hydrogen production operation indicator that indicates one or more predicted operation and performance levels associated with the hydrogen production facility in producing hydrogen if the adjusted hydrogen production variable indicator is implemented.

Referring back to FIG. 7, subsequent to and/or response to step/operation 705, the example method 700 proceeds to step/operation 707. At step/operation 707, a computing device (such as, but not limited to, the example autonomous artificial intelligence agent computing device described and illustrated above in connection with FIG. 1 and FIG. 2) may determine whether the predicted hydrogen production operation indicator satisfies the corresponding hydrogen production operation threshold indicator.

In some embodiments, the computing device determines whether the predicted hydrogen production operation indicator generated at step/operation 705 satisfies the corresponding hydrogen production operation threshold indicator similar to those described above in connection with at least step/operation 408 of FIG. 4B.

If, at step/operation 707, the computing device determines that the predicted hydrogen production operation indicator satisfies the corresponding hydrogen production operation threshold indicator, the example method 700 proceeds to step/operation 709. At step/operation 709, a computing device (such as, but not limited to, the example autonomous artificial intelligence agent computing device described and illustrated above in connection with FIG. 1 and FIG. 2) may transmit the adjusted hydrogen production variable indicator to the hydrogen production control system.

For example, in response to determining that the at least one predicted hydrogen production operation indicator satisfies the at least one corresponding hydrogen production operation threshold indicator, the computing device transmits the adjusted hydrogen production variable indicator to the hydrogen production control system. In some embodiments, upon receiving the adjusted hydrogen production variable indicator, the hydrogen production control system may adjust the corresponding hydrogen production variable indicator. For example, the hydrogen production control system may modify one or more processes and/or operations associated with the hydrogen production facility in producing hydrogen.

Referring back to FIG. 7, subsequent to and/or response to step/operation 709, the example method 700 proceeds to step/operation 711 and ends.

If, at step/operation 707, the computing device determines that the predicted hydrogen production operation indicator does not satisfy the corresponding hydrogen production operation threshold indicator, the example method 700 returns to step/operation 703. Similar to those described above, at step/operation 703, a computing device (such as, but not limited to, the example autonomous artificial intelligence agent computing device described and illustrated above in connection with FIG. 1 and FIG. 2) may generate an adjusted hydrogen production variable indicator.

For example, the computing device may generate an adjusted hydrogen production variable indicator that is different from the previously generated adjusted hydrogen production variable indicator.

As described above, various embodiments of the present disclosure provide various technical improvements to various technologies and technological fields such as, but not limited to, the field of hydrogen manufacturing. For example, FIG. 7 illustrates an example of feedback control based at least in part on continuously adjusting the hydrogen production variable indicators such that the predicted hydrogen production operation indicator satisfies the corresponding hydrogen production operation threshold indicator, which may improve the safely level associated with manufacturing hydrogen, reduce the cost associated with manufacturing hydrogen, and reduce the likelihood of critical errors or failures during manufacturing.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

1. An apparatus comprising at least one processor and at least one non-transitory memory comprising a computer program code, the at least one non-transitory memory and the computer program code configured to, with the at least one processor, cause the apparatus to:
receive a plurality of runtime hydrogen production variable indicators from a hydrogen production control system associated with a hydrogen production facility;
generate at least one predicted hydrogen production operation indicator based at least in part on inputting the plurality of runtime hydrogen production variable indicators to one or more hydrogen production machine learning models;
determine whether the at least one predicted hydrogen production operation indicator satisfies at least one corresponding hydrogen production operation threshold indicator associated with the hydrogen production facility; and
in response to determining that the at least one predicted hydrogen production operation indicator does not satisfy the at least one corresponding hydrogen production operation threshold indicator:
generate an adjusted hydrogen production variable indicator corresponding to a runtime hydrogen production variable indicator of the plurality of runtime hydrogen production variable indicators; and
transmit the adjusted hydrogen production variable indicator to the hydrogen production control system.

2. The apparatus of claim 1, wherein the plurality of runtime hydrogen production variable indicators comprises a production power source variable indicator, a hydrogen production quantity variable indicator, a hydrogen storage location variable indicator, and a hydrogen transport plan variable indicator.

3. The apparatus of claim 1, wherein the at least one predicted hydrogen production operation indicator comprises a predicted hydrogen production safety indicator, wherein the one or more hydrogen production machine learning models comprise a hydrogen production safety prediction machine learning model.

4. The apparatus of claim 3, wherein the at least one non-transitory memory and the computer program code are configured to, with the at least one processor, cause the apparatus to:
receive a plurality of historical hydrogen production variable indicators associated with the hydrogen production facility;
receive a plurality of historical hydrogen production safety indicators associated with the hydrogen production facility; and
train the hydrogen production safety prediction machine learning model based at least in part on the plurality of historical hydrogen production variable indicators and the plurality of historical hydrogen production safety indicators.

5. The apparatus of claim 1, wherein the at least one predicted hydrogen production operation indicator comprises a predicted hydrogen production cost indicator, wherein the one or more hydrogen production machine learning models comprise a hydrogen production cost prediction machine learning model.

6. The apparatus of claim 5, wherein the at least one non-transitory memory and the computer program code are configured to, with the at least one processor, cause the apparatus to:
receive a plurality of historical hydrogen production variable indicators associated with the hydrogen production facility;
receive a plurality of historical hydrogen production cost indicators associated with the hydrogen production facility; and
train the hydrogen production cost prediction machine learning model based at least in part on the plurality of historical hydrogen production variable indicators and the plurality of historical hydrogen production cost indicators.

7. The apparatus of claim 1, wherein the plurality of runtime hydrogen production variable indicators comprises the runtime hydrogen production variable indicator and one or more additional runtime hydrogen production variable indicators.

8. The apparatus of claim 7, wherein, prior to transmitting the adjusted hydrogen production variable indicator, the at least one non-transitory memory and the computer program code are configured to, with the at least one processor, cause the apparatus to:
generate a predicted hydrogen production operation indicator based at least in part on inputting the adjusted hydrogen production variable indicator and the one or more additional runtime hydrogen production variable indicators to the one or more hydrogen production machine learning models;
determine whether the predicted hydrogen production operation indicator satisfies the at least one corresponding hydrogen production operation threshold indicator; and
in response to determining that the predicted hydrogen production operation indicator satisfies the at least one corresponding hydrogen production operation threshold indicator, transmit the adjusted hydrogen production variable indicator to the hydrogen production control system.

9. A computer-implemented method comprising:
receiving a plurality of runtime hydrogen production variable indicators from a hydrogen production control system associated with a hydrogen production facility;
generating at least one predicted hydrogen production operation indicator based at least in part on inputting the plurality of runtime hydrogen production variable indicators to one or more hydrogen production machine learning models;
determining whether the at least one predicted hydrogen production operation indicator satisfies at least one corresponding hydrogen production operation threshold indicator associated with the hydrogen production facility; and
in response to determining that the at least one predicted hydrogen production operation indicator does not satisfy the at least one corresponding hydrogen production operation threshold indicator:
generating an adjusted hydrogen production variable indicator corresponding to a runtime hydrogen production variable indicator of the plurality of runtime hydrogen production variable indicators; and
transmitting the adjusted hydrogen production variable indicator to the hydrogen production control system.

10. The computer-implemented method of claim 9, further comprising:
receiving a plurality of historical hydrogen production variable indicators associated with the hydrogen production facility;
receiving a plurality of historical hydrogen production safety indicators associated with the hydrogen production facility; and
training the hydrogen production safety prediction machine learning model based at least in part on the plurality of historical hydrogen production variable indicators and the plurality of historical hydrogen production safety indicators.

11. The computer-implemented method of claim 9, wherein the plurality of runtime hydrogen production variable indicators comprises a production power source variable indicator, a hydrogen production quantity variable indicator, a hydrogen storage location variable indicator, and a hydrogen transport plan variable indicator.

12. The computer-implemented method of claim 9, wherein the at least one predicted hydrogen production operation indicator comprises a predicted hydrogen production cost indicator, wherein the one or more hydrogen production machine learning models comprise a hydrogen production cost prediction machine learning model.

13. The computer-implemented method of claim 12, further comprising:
receiving a plurality of historical hydrogen production variable indicators associated with the hydrogen production facility;
receiving a plurality of historical hydrogen production cost indicators associated with the hydrogen production facility; and
training the hydrogen production cost prediction machine learning model based at least in part on the plurality of historical hydrogen production variable indicators and the plurality of historical hydrogen production cost indicators.

14. The computer-implemented method of claim 9, wherein the plurality of runtime hydrogen production variable indicators comprises the runtime hydrogen production variable indicator and one or more additional runtime hydrogen production variable indicators.

15. The computer-implemented method of claim 14, further comprising:
generating a predicted hydrogen production operation indicator based at least in part on inputting the adjusted hydrogen production variable indicator and the one or more additional runtime hydrogen production variable indicators to the one or more hydrogen production machine learning models;
determining whether the predicted hydrogen production operation indicator satisfies the at least one corresponding hydrogen production operation threshold indicator; and
in response to determining that the predicted hydrogen production operation indicator satisfies the at least one corresponding hydrogen production operation threshold indicator, transmit the adjusted hydrogen production variable indicator to the hydrogen production control system.

16. A non-transitory computer-readable storage medium comprising one or more programs for execution by one or more processors of a device, the one or more programs including instructions which, when executed by the one or more processors, cause the device to:
receive a plurality of runtime hydrogen production variable indicators from a hydrogen production control system associated with a hydrogen production facility;
generate at least one predicted hydrogen production operation indicator based at least in part on inputting the plurality of runtime hydrogen production variable indicators to one or more hydrogen production machine learning models;
determine whether the at least one predicted hydrogen production operation indicator satisfies at least one corresponding hydrogen production operation threshold indicator associated with the hydrogen production facility; and
in response to determining that the at least one predicted hydrogen production operation indicator does not satisfy the at least one corresponding hydrogen production operation threshold indicator:
generate an adjusted hydrogen production variable indicator corresponding to a runtime hydrogen production variable indicator of the plurality of runtime hydrogen production variable indicators; and
transmit the adjusted hydrogen production variable indicator to the hydrogen production control system.

17. The non-transitory computer-readable storage medium of claim 16, wherein the at least one predicted hydrogen production operation indicator comprises a predicted hydrogen production safety indicator, wherein the one or more hydrogen production machine learning models comprise a hydrogen production safety prediction machine learning model.

18. The non-transitory computer-readable storage medium of claim 17, wherein the device is further configured to:
receive a plurality of historical hydrogen production variable indicators associated with the hydrogen production facility;
receive a plurality of historical hydrogen production safety indicators associated with the hydrogen production facility; and
train the hydrogen production safety prediction machine learning model based at least in part on the plurality of historical hydrogen production variable indicators and the plurality of historical hydrogen production safety indicators.

19. The non-transitory computer-readable storage medium of claim 16, wherein the at least one predicted hydrogen production operation indicator comprises a predicted hydrogen production cost indicator, wherein the one or more hydrogen production machine learning models comprise a hydrogen production cost prediction machine learning model.

20. The non-transitory computer-readable storage medium of claim 19, wherein the device is further configured to:
receive a plurality of historical hydrogen production variable indicators associated with the hydrogen production facility;
receive a plurality of historical hydrogen production cost indicators associated with the hydrogen production facility; and
train the hydrogen production cost prediction machine learning model based at least in part on the plurality of historical hydrogen production variable indicators and the plurality of historical hydrogen production cost indicators.
